(19) United States
(12) Patent Application Publication
(10) Pub. No.: US 2025/0039844 A1
(43) Pub. Date: Jan. 30, 2025

(54) METHODS AND WIRELESS NETWORK FOR MANAGING PAGING OPERATION

(71) Applicant: Samsung Electronics Co., Ltd., Suwon-si, Gyeonggi-do (KR)

(72) Inventors: Vinay Kumar SHRIVASTAVA, Suwon-si (KR); Sriganesh RAJENDRAN, Suwon-si (KR); Varini GUPTA, Suwon-si (KR); Sangkyu BAEK, Suwon-si (KR)

(21) Appl. No.: 18/711,781

(22) PCT Filed: Nov. 25, 2022
(86) PCT No.: PCT/KR2022/018805

§ 371 Date: May 20, 2024

(30) Foreign Application Priority Data
Nov. 25, 2021 (IN) 202141054592
Jan. 24, 2022 (IN) 202241003932
Nov. 3, 2022 (IN) 2021 41054592

(51) Int. Cl. H04W 68/02; H04W 4/08; H04W 76/27; H04W 76/28

(52) U.S. Cl. CPC H04W 68/02; H04W 4/08; H04W 76/27; H04W 76/28

(57) ABSTRACT

The disclosure relates to a 5G or 6G communication system for supporting a higher data transmission rate. Embodiments herein disclose methods for managing a paging operation in a wireless network (1000) by a UE (100). The method includes receiving a paging message from a network device (200), where the UE (100) is in a Radio Resource Control (RRC) inactive state. Further, the method includes determining whether the UE (100) has received at least one of a core network (CN) paging and a group paging in the paging message. Further, the method includes sending at least one of a UE identity, an access type and a Temporary Mobile Group Identity (TMGI) to an upper layer upon determining that the UE (100) simultaneously receives the CN paging and the group paging in the paging message. Further, the method includes transiting the UE (100) into a Radio Resource Control (RRC) idle state from the RRC inactive state.

### TECHNICAL FIELD

The present disclosure relates to a wireless communication, and more specifically related to a method for handling a paging operation for a Multicast Broadcast Service (MBS) in the wireless networks (e.g., 5^{th} generation (5G) wireless communication network or the like).

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The principal object of the embodiments herein is to disclose methods and systems for managing a paging operation in a wireless network. The method enables handling of multicast group paging and unicast paging accurately and appropriately.

Another object of the embodiments herein is to provide a paging reception approach for MBS for 5^{th} generation (5G) wireless communication networks. Reception of a paging message by the UE is updated to specify the handling of reception of paging message containing both group paging identifier (ID) the UE is monitoring and the CN paging UE identity when the UE is in a RRC INACTIVE state. If the CN paging for the UE is present (i.e. UE identity in the CN paging carries at least one paging record with UE identity that matches with the UE identity allocated by the upper layers) along with group paging (i.e. group paging carries at least one TMGI (MBS session identity) that UE has joined) in the same paging message, the UE initiates procedure to move to an RRC IDLE state and does not perform action related to reception of group paging i.e. UE does not resume the RRC connection.

Another object of the embodiments herein is to provide group paging UEs for the NR MBS.

Another object of the embodiments herein is to provide that the UE handles a reception of CN paging along with group paging in the same paging message.

Another object of the embodiments herein is to provide that the UE is in an INACTIVE state transition to an IDLE state when a paging message with CN paging and relevant group paging for multicast session for the UE is received.

Another object of the embodiments herein is to provide a group paging cause to address the handling of group paging message indicating session release and session deactivation.

Another object of the embodiments herein is to provide a UE specific Discontinuous reception (DRX) used for multicast group paging by the network entity.

### Solution to Problem

Accordingly, the embodiments herein provide methods for managing a paging operation in a wireless network. The method includes receiving, by a User Equipment (UE), a paging message from a network device. The UE is in a Radio Resource Control (RRC) inactive state. Further, the method includes determining, by the UE, whether the UE has received at least one of a core network (CN) paging and a group paging in the paging message. Further, the method includes sending, by the UE, at least one of a UE identity, an access type and a Temporary Mobile Group Identity (TMGI) to an upper layer upon determining that the UE simultaneously receives the CN paging and the group paging in the paging message. Further, the method includes transiting, by the UE, the UE into a Radio Resource Control (RRC) idle state from the RRC inactive state.

In an embodiment, the method includes determining, by the UE, that the UE, in the RRC inactive state, receives the CN paging only in the paging message upon determining that the UE does not simultaneously receive the CN paging and the group paging in the paging message. Further, the method includes sending, by the UE, at least one of the UE identity and the access type to the upper layer and transiting the UE into the RRC idle state upon determining that the UE receives the CN paging only in the paging message.

In an embodiment, the method includes determining, by the UE, that the UE, in the RRC inactive state, receives the group paging only in the paging message upon determining that the UE does not simultaneously receive the CN paging and the group paging in the paging message. Further, the method includes performing, by the UE, at least one of: sending of the TMGI to the upper layer and initiating a RRC connection resume procedure upon determining that the UE receives the group paging only in the paging message.

In an embodiment, the group paging includes a multicast session group notification, and wherein the group paging is provided through a paging group list in the paging message carrying a list of TMGIs for which a session status is explicitly or implicitly indicated.

In an embodiment, the session status is explicitly indicated in which the paging group list comprises a field indicating a group paging cause of the group paging, wherein the field is present along with each TMGI in the paging group list or a common field for all the TMGIs in the paging group list.

In an embodiment, the group paging cause includes at least one of a session release, a session activation, a session deactivation, and a session start.

In an embodiment, the session status is implicitly indicated in which the group paging is interpreted for session activation by default when the group paging cause field is not present in the paging message.

In an embodiment, the session status is implicitly indicated in which the group paging cause field is not provided and the cause of the paging is determined by the UE after getting connected to the network device and receiving a RRC reconfiguration message from the network device.

In an embodiment, the UE receives the paging message for the group paging following its UE specific Discontinuous Reception mechanism (DRX) parameter, wherein the UE specific DRX parameter comprises a paging DRX cycle length.

Accordingly, the embodiments herein provide methods for handling a paging operation in a wireless network. The method includes receiving, by a User Equipment (UE), a group paging through a paging group list in a paging message comprising a list of Temporary Mobile Group Identities (TMGIs) for which a session status is explicitly or implicitly indicated. The paging group list in the paging message comprises a field indicating a cause of the group paging. The field is present along with each TMGI in the paging group list or a common field for all the TMGIs in the paging group list. Further, the method includes performing, by the UE, at least one action based on the group paging.

In an embodiment, performing, by the UE, the at least one action includes determining, by the UE, whether the UE, in a RRC idle state or a RRC inactive state, receiving the group paging with the group paging cause is not present or the group paging cause is set to activation, and in response to determining that the UE receiving the group paging with the group paging cause is not present or the group paging cause is set to activation, sending at least one of a TMGI and the group paging cause to an upper layer and initiating a RRC connection establishment if the UE is in the RRC idle state or a RRC connection resume procedure with a resume cause set in accordance with an access identity configured by the upper layer if the UE is in the RRC inactive state, or in response to determining that the UE receiving the group paging with the group paging cause is present and the group paging cause is set to release or the group paging cause is not set to activation, determining that the UE receives the group paging with the group paging cause set to release.

In an embodiment, the method includes sending, by the UE, at least one of the TMGI and the group paging cause to the upper layer upon determining that the UE receives the group paging with the group paging cause set to release. Further, the method includes stopping, by the UE, monitoring of the group paging for TMGI.

In an embodiment, the UE is in one of a RRC inactive state and a RRC idle state.

Accordingly, the embodiments herein provide methods for handling a paging operation in a wireless network. The method includes utilizing, by a network device in the wireless network, a User Equipment (UE) specific Discontinuous Reception mechanism (DRX) parameter to page a UE for a paging message in one of a Radio Resource Control (RRC) idle state and a RRC inactive state, wherein the UE specific DRX parameter comprises a paging DRX cycle length. The paging message is at least one of a group paging message, a multicast group paging message, and a RAN multicast group paging message; Further, the method includes handling, by the network device, the paging operation in the wireless network based on the UE specific DRX parameter.

In an embodiment, the network device includes at least one of a New Generation-Radio Access Network (NG-RAN) node and a core network node.

In an embodiment, upon determining the paging message is the RAN multicast group paging message when the UE transits from a coverage of a first NG-RAN node to a coverage of a second NG-RAN node, the first NG-RAN node sends the RAN multicast group paging message including the UE specific DRX parameter to a second NG-RAN RAN node.

In an embodiment, upon determining the paging message is the multicast group paging message for the at least one NG-RAN node that has the UE in the coverage, wherein the core network sends the multicast group paging message including the UE specific DRX parameter to a NG-RAN node.

In an embodiment, upon determining the paging message is the group paging message for the UE in a coverage area, wherein a NG-RAN node sends the group paging message based on the UE specific DRX parameter to the UE.

Accordingly, the embodiments herein provide a UE including a paging operation controller coupled with a processor and a memory. The paging operation controller receives a paging message from a network device, wherein the UE is in a Radio Resource Control (RRC) inactive state. Further, the paging operation controller determines whether the UE has received at least one of a CN paging and a group paging in the paging message. Further, the paging operation controller sends at least one of a UE identity, an access type and a Temporary Mobile Group Identity (TMGI) to an upper layer upon determining that the UE simultaneously receives the CN paging and the group paging in the paging message. Further, the paging operation controller transits the UE into a Radio Resource Control (RRC) idle state from the RRC inactive state.

Accordingly, the embodiments herein provide a UE including a paging operation controller coupled with a processor and a memory. The paging operation controller receives a group paging through a paging group list in a paging message comprising a list of Temporary Mobile Group Identities (TMGIs) for which a session status is explicitly or implicitly indicated, wherein the paging group list in the paging message comprises a field indicating a cause of the group paging, wherein the field is present along with each TMGI in the paging group list or a common field for all the TMGIs in the paging group list. Further, the paging operation controller performs at least one action based on the group paging.

In an embodiment, UE performs the at least one action includes determine whether the UE, in a RRC idle state or a RRC inactive state, receiving the group paging with the group paging cause is not present or the group paging cause is set to activation, and in response to determine that the UE receiving the group paging with the group paging cause is not present or the group paging cause is set to activation, sending at least one of a TMGI and the group paging cause to an upper layer and initiating a RRC connection establishment if the UE is in the RRC idle state or a RRC connection resume procedure with a resume cause set in accordance with an access identity configured by the upper layer if the UE is in the RRC inactive state, or in response to determine that the UE receiving the group paging with the group paging cause is present and the group paging is set to release or the group paging cause is not set to activation, determining that the UE receives the group paging with the group paging cause set to release.

Accordingly, the embodiments herein provide a network device including a paging operation controller coupled with a processor and a memory. The paging operation controller is configured to utilize a UE specific DRX parameter to page a UE for a paging message in one of a RRC idle state and a RRC inactive state, wherein the paging message is at least one of Group Paging, Multicast Group Paging, and RAN Multicast Group Paging. The UE specific DRX parameter includes a paging DRX cycle length. The paging operation controller is configured to handle the paging operation in the wireless network based on the UE specific DRX parameter.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### Advantageous Effects of Invention

The method and apparatus according to embodiments of the disclosure may manage a paging operation in a wireless network. The method enables handling of multicast group paging and unicast paging accurately and appropriately.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1A is an example overview of a wireless network for handling a paging operation, according to the embodiments as disclosed herein;

FIG. 1B shows various hardware components of a UE, according to the embodiments as disclosed herein;

FIG. 1C shows various hardware components of a network device, according to the embodiments as disclosed herein;

FIG. 2 is a sequence diagram depicting a proposed procedure followed by the UE to request for a UE specific paging DRX cycle for receiving MBS group paging or group notification in a RRC_IDLE or a RRC_INACTIVE state, when the UE joins an MBS session, and the UE uses the proposed procedure by sending a registration request message with requested DRX parameter IE, according to embodiments as disclosed herein;

FIG. 3 is a sequence diagram depicting a common MBS DRX configuration signalled as part of System Information Block #1 (SIB1) or other SIB message for receiving MBS group paging or group notification in a RRC_IDLE or a RRC_INACTIVE state, according to embodiments as disclosed herein;

FIG. 4 is a sequence diagram depicting a MBS feature specific paging DRX cycle being configured as part of the MBS session join procedure for receiving MBS group paging or group notification in RRC_IDLE or RRC_INACTIVE state, according to embodiments as disclosed herein;

FIG. 5 is a sequence diagram depicting a MBS feature specific paging DRX cycle being configured as part of a connection release procedure in a RRC release message or RRC release with suspendConfig message for receiving MBS group paging or group notification in a RRC_IDLE or a RRC_INACTIVE state, according to embodiments as disclosed herein;

FIG. 6 is a sequence diagram depicting a MBS session specific paging DRX cycle being configured as part of the MBS session join procedure for receiving MBS group paging or group notification in RRC_IDLE or RRC_INACTIVE state, according to embodiments as disclosed herein;

FIG. 7 is a sequence diagram depicting the MBS session specific paging DRX cycle being configured as part of the Connection release procedure in RRC Release message or RRC release with suspendConfig message for receiving MBS group paging or group notification in RRC_IDLE or RRC_INACTIVE state, according to embodiments as disclosed herein;

FIG. 8 is a flow chart illustrating a scenario of group paging for the UE in a RRC_INACTIVE state, according to the embodiments as disclosed herein;

FIG. 9 is a flow chart illustrating a scenario of group paging procedure for the UE in the RRC_IDLE state, according to the embodiments as disclosed herein;

FIG. 10 is a flow chart illustrating a scenario of paging procedure for the UE in the RRC_INACTIVE where a CN paging and group paging are received in the same paging message, according to the embodiments as disclosed herein;

FIG. 11 is a flow chart illustrating a scenario of paging procedure for the UE in the RRC_IDLE wherein the CN paging and the group paging are received in the same paging message, according to the embodiments as disclosed herein;

FIG. 12 is a flow chart illustrating, implemented by the UE, methods for handling the paging operation in the wireless network, according to the embodiments as disclosed herein;

FIG. 13 is a flow chart illustrating, implemented by the UE, methods for handling the paging operation in the wireless network, according to the embodiments as disclosed herein; and

FIG. 14 is a flow chart illustrating methods, implemented by the network device, for handling the paging operation in the wireless network, according to the embodiments as disclosed herein.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Further, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more central processing units (CPUs) within a device or a security multimedia card. Further, the “unit” in the embodiments may include one or more processors.

In the following description of the disclosure, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

In the following description, terms for identifying access nodes, terms referring to network entities, terms referring to messages, terms referring to interfaces between network entities, terms referring to various identification information, and the like are illustratively used for the sake of convenience. Therefore, the disclosure is not limited by the terms as used below, and other terms referring to subjects having equivalent technical meanings may be used.

In the following description, the disclosure will be described using terms and names defined in the 3rd generation partnership project long term evolution (3GPP LTE) standards for the convenience of description. However, the disclosure is not limited by these terms and names, and may be applied in the same way to systems that conform other standards. In the disclosure, the term “eNB” may be interchangeably used with the term “gNB”. That is, a base station described as “eNB” may indicate “gNB”.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing communication functions. Of course, examples of the base station and the terminal are not limited thereto.

In the following description of embodiments of the disclosure, LTE, LTE advanced (LTE-A), LTE Pro, or 5G (or new radio (NR), next-generation mobile communication) systems will be described by way of example, but the embodiments of the disclosure may be applied to other communication systems having similar backgrounds or channel types. Further, based on determinations by those skilled in the art, the embodiments of the disclosure may be applied to other communication systems through some modifications without significantly departing from the scope of the disclosure.

In the following description of the disclosure, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

In wireless networks, there are certain issues related to following aspects of paging for MBS (e.g., for multicast session activation notification):
1. Paging resource efficiency: How to ensure a paging resource efficiency is maximized for multicast session group notification and it does not affect a paging capacity of legacy nodes adversely.
2. Addressing RRC_IDLE and RRC_INACTIVE UEs: How the mechanism works for User Equipment's (UEs) in different radio resource control (RRC) states such as RRC_IDLE and RRC_INACTIVE.
3. Addressing MBS and non-MBS nodes: How to ensure the mechanism works for different capability nodes and/or legacy nodes which may not be MBS supporting.
4. Network signalling and interfaces: what and how are the signalling messages and interactions over interfaces between different network entities are performed.

Further, a New Radio (NR) Multicast Broadcast Services (MBS) services include:
a. Multicast services for which the wireless networks transfer common user data that is intended to be received only by a specific group of User Equipment's (UEs) which have joined the concerned multicast group.
b. Broadcast services for which the network transfers common user data that can be received by all UEs interested to receive the service.

Further, the NR MBS services can refer to multicast services where intended common contents are targeted to a group of UEs which have joined the multicast group in a multicast coverage area and broadcast services where intended contents may be targeted to all the UEs in a broadcast coverage area. These coverage area can be one cell or larger.

Two delivery methods are envisioned for 5G MBS service, from the view point of 5G Core Network (CN): Individual MBS traffic delivery method, and shared MBS traffic delivery method.

For the individual MBS traffic delivery method, the CN receives a single copy of MBS data packets and delivers separate copies of those MBS data packets to individual UEs via per-UE Protocol Data Unit (PDU) sessions. For the shared MBS traffic delivery method, the 5G CN receives a single copy of MBS data packets and delivers a single copy of those MBS packets packet to a Radio Access Node (RAN), which then delivers them to one or multiple UEs. The RAN delivers MBS data to the UEs using either Point-to-Point delivery (PTP) or Point-to-Multipoint (PTM) delivery. Further, at the UE, the MBS bearer can be composed of a common Packet Data Convergence Protocol (PDCP) entity with PTP, PTM or a combination of PTP and PTM legs or RLC (Radio Link Control) entities.

For the purpose of informing UEs in the RRC_IDLE state or RRC_INACTIVE state about multicast session activation, a group notification or group paging is utilized. Based on this paging, the UE transits to RRC_CONNECTED state and starts receiving the multicast session.

One potential issue is that the UEs for which multicast session is deactivated may be transitioned to the RRC_IDLE state or RRC_INACTIVE state and starts monitoring for group notification (or group paging) for session activation. Moreover, the UEs for which multicast session is activated may also possibly be transitioned to RRC_INACTIVE state by the network (e.g. when there is no data activity for some time). However, it is possible that the relevant multicast session is released by the wireless network while the UE is being in the RRC_IDLE state or RRC_INACTIVE state. However, as the UE is being in the RRC_IDLE state or RRC_INACTIVE state, it is not aware about the session release and will indefinitely monitor for the group paging message.

This may be drastic from power saving and processing perspective. Moreover, an upper layer (e.g. Non-Access Stratum (NAS)) may also not be informed as there is no NAS signalling received. On the other hand, if the network does send a NAS layer signalling, it may require transition of individual UEs to the RRC_CONNECTED state just for release purpose, and this will cause massive signalling burden.

Another issue relates to a scenario when the UE, in the RRC_INACTIVE state, receives CN paging and multicast session group notification (i.e. group paging) in the same paging message.

Thus there is a need of methods and systems, in which the UE may face a dilemma as to handle one of the two paging or handle both the paging and describes the scenario of how to handle the situation.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

The embodiments herein achieve methods for managing a paging operation in a wireless network. The method includes receiving, by a User Equipment (UE), a paging message from a network device. The UE is in a Radio Resource Control (RRC) inactive state. Further, the method includes determining, by the UE, whether the UE has received at least one of a core network (CN) paging and a group paging in the paging message. Further, the method includes sending, by the UE, at least one of a UE identity, an access type and a Temporary Mobile Group Identity (TMGI) to an upper layer upon determining that the UE simultaneously receives the CN paging and the group paging in the paging message. Further, the method includes transiting, by the UE, the UE into a Radio Resource Control (RRC) idle state from the RRC inactive state.

The proposed method provides a scenario to handle simultaneous reception of the CN paging and group paging in the same paging message by the UE in RRC_INACTIVE state. Further, the proposed method provides a scenario to support efficient provision to inform the UEs in RRC_IDLE state or RRC_INACTIVE state about the multicast session release.

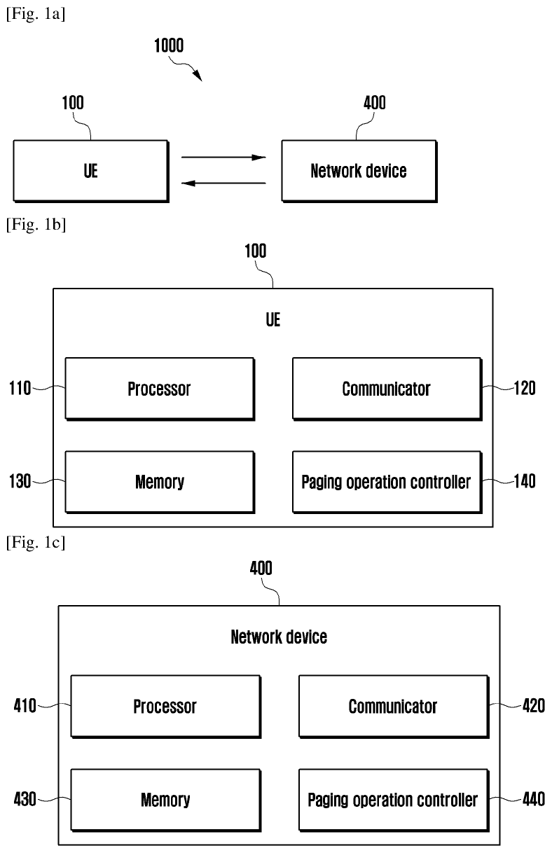

Referring now to the drawings, and more particularly to FIGS. 1A through 14, where similar reference characters denote corresponding features consistently throughout the figures, there are shown at least one embodiment.

FIG. 1A is an example overview of a wireless network (1000) for handling a paging operation, according to the embodiments as disclosed herein. The wireless network (1000) can be, for example, but not limited to a 5G network, a sixth generation (6G) network, an Open Radio Access Network (ORAN) or the like. The wireless network (1000) includes a UE (100) and a network device (400). The UE (100) can be, for example, but not limited to a smart laptop, a smart computer, a smart Device-to-Device (D2D) device, a smart vehicle to everything (V2X) device, a smartphone, a smart foldable phone, a smart TV, a television, an immersive device, or the like. The network device (400) can be a Radio Access Network (RAN) entity like gNB or a Core Network (CN) device like Access and Mobility Management Function (AMF).

The UE (100) receives a paging message from the network device (400), where the UE (100) is in a RRC inactive state. Further, the UE (100) determines whether the UE (100) has received at least one of a CN paging and a group paging in the paging message. Upon determining that the UE (100) simultaneously receives the CN paging and the group paging in the paging message, the UE (100) sends a UE identity, an access type and a TMGI (i.e. a MBS session identity) to the upper layer (e.g. NAS layer or the like) and transits the UE (100) into the RRC idle state.

Further, the upper layer may use at least one of UE identity and TMGI to determine the paging response and cause for the establishment of the RRC connection.

In an embodiment, the UE (100) determines that the UE (100), in the RRC inactive state, receives the CN paging only in the paging message upon determining that the UE (100) does not simultaneously receive the CN paging and the group paging in the paging message. Further, the UE (100) sends the UE identity and the access type to the upper layer and transits the UE (100) into the RRC idle state upon determining that the UE (100) receives the CN paging only in the paging message.

In another embodiment, the UE (100) determines that the UE (100), in the RRC inactive state, receives the group paging only in the paging message upon determining that the UE (100) does not simultaneously receive the CN paging and the group paging in the paging message. Further, the UE (100) performs at least one of: sending of the TMGI to the upper layer and initiates a RRC connection resume procedure upon determining that the UE (100) receives the group paging only in the paging message.

In another embodiment, the UE (100) receives the group paging through a paging group list in the paging message comprising a list of TMGIs for which a session status is explicitly or implicitly indicated. The paging group list in the paging message includes a field indicating a cause of the group paging, where the UE (100) is in one of a RRC inactive state and a RRC idle state. The field is present along with each TMGI in the paging group list or a common field for all the TMGIs in the paging group list.

Based on the group paging, the UE (100) determines whether the UE (100), in the RRC idle state or a RRC inactive state, receiving the group paging with the group paging cause is not present or the group paging cause is set to activation. In response to determine that the UE (100) receiving the group paging with the group paging cause is not present or the group paging cause is set to activation, the UE (100) sends the TMGI and the group paging cause to the upper layer and initiates a RRC connection establishment if the UE (100) is in the RRC idle state or a RRC connection resume procedure with a resume cause set in accordance with an access identity configured by the upper layer if the UE (100) is in the RRC inactive state.

Alternatively, in response to determine that the UE (100) receiving the group paging with the group paging cause is present and the group paging cause is set to release or the group paging cause is not set to activation, the UE (100) determines that the UE (100) receives the group paging with the group paging cause set to release. Further, the UE (100) may send the TMGI and the group paging cause to the upper layer upon determining that the UE (100) receives the group paging with the group paging cause set to release. Further, the UE (100) stops monitoring of the group paging for TMGI.

In an embodiment, a paging mechanism is used for multicast session activation notification. However, considering the UE impact, paging for MBS need to coexist on legacy paging occasions. That is, effectively, the paging for the MBS is provided as an extension of paging message used for legacy purposes. Evidently, the paging for the MBS impacts the paging capacity of the legacy unicast services. Further, there can be two approaches to do paging for multicast session activation notification. With approach 1:
1. Paging for multicast session activation notification is used in all legacy Paging Occasions (POs).
2. Paging for multicast session activation notification is used in the relevant legacy POs for the UEs (100) with non-activated multicast session(s).

With approach 2, there is enhanced paging resource efficiency.
1. Paging for the MBS session activation notification will be limited to specific (relevant) paging occasions for the UEs (100) which had non-activated MBS multicast session(s). Non-activated multicast session can correspond to the session which is configured or joined but it is not yet activated or it is deactivated after it was activated.
2. Moreover, this relevant legacy paging occasion will carry only paging records for the relevant activated TMGIs for UEs pertinent to paging occasions. As compared, approach 1 wherein each legacy paging occasion needs to carry paging records for all the TMGIs which are activated.

Further, in an embodiment, it is also possible that the UE (100) is transitioned to the RRC_INACTIVE state while the multicast session is in the activated state (e.g. the network device (400) does not see any data activity for multicast session for some time) and the UE (100) in the RRC_INACTIVE state is informed for the multicast data arrival with the group paging. Though there may not be any paging cause indicated in the group paging, the UE (100) which is in RRC_INACTIVE state implicitly determines from the group paging with the relevant TMGI that there is a multicast data arrival case. The UE (100) transits to RRC_CONNECTED state and then continues receiving the multicast session.

Therefore, there are two-fold advantages with paging resource efficiency with approach 2.

In an embodiment, the network device (400) (e.g., Access and Mobility Management Function (e.g., (AMF), gNB or the like) utilizes the UE specific DRX(s) to page the UE (100) for the MBS group paging or group notification (e.g., multicast session activation) in the RRC_IDLE or the RRC_INACTIVE state. The network device (400) (e.g., “network node”) may indicate if it pages the UE (100) for the group notification, the network device (400) may indicate if it supports MBS for the UE (100) to check if it should monitor group paging or group notification). This implies that the UE (100) receives the paging message for group notification following its UE specific DRX parameter. The UE specific parameter can include, but not limited to, paging DRX cycle length. In an embodiment, the UE specific DRX parameter can be the same or different for different MBS multicast sessions, which the UE (100) has joined and accordingly, the UE (100) in the RRC_IDLE or the RRC_INACTIVE state monitors paging for the group notification for respective multicast session as per pertinent multicast session related UE specific DRX parameter.

In an embodiment, the UE (100) uses the legacy UE specific DRX cycles for calculating T (i.e. paging DRX cycle length) to monitor group paging or group notification. The UE (100), which is interested in joining the MBS session, initiates a session join procedure. The UE (100) can request for a UE specific DRX cycle, if the default DRX cycle configured from the System Information (SI) and/or the previously configured UE specific DRX paging cycle does not meet the requirements of the joined MBS session. The UE (100) requests for the UE specific paging DRX cycle by triggering a registration request with requested DRX parameter Information Element (IE) specifying the preferred DRX cycle value suitable for meeting the requirements (such as latency) of the joined MBS session(s).

In an embodiment, the network device (400) (e.g., AMF, gNB or the like) utilizes multicast session specific DRX(s) to page the UE (100) for the MBS group paging or group notification (e.g., multicast session activation) in the RRC_IDLE or the RRC_INACTIVE state. The network device (400) may indicate if the network device (400) pages the UE (100) for group notification (e.g. the network device (400) may indicate if it supports MBS for the UE (100) to check if it should monitor group paging or group notification). This implies that the UE (100) receives the paging message for group notification following its multicast session specific DRX parameter. The session specific DRX parameter can include, but is not limited to, paging DRX cycle length. In an embodiment, the session specific DRX parameter can be the same or different for different MBS multicast sessions, which the UE (100) has joined and accordingly, the UE (100) in the RRC_IDLE or RRC_INACTIVE state monitors paging for the group notification for respective multicast session as per pertinent multicast session specific DRX parameter.

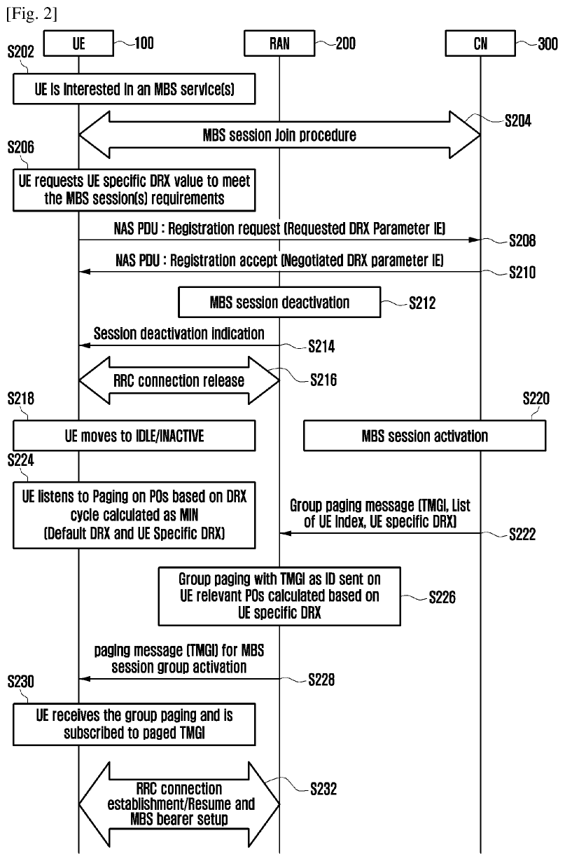

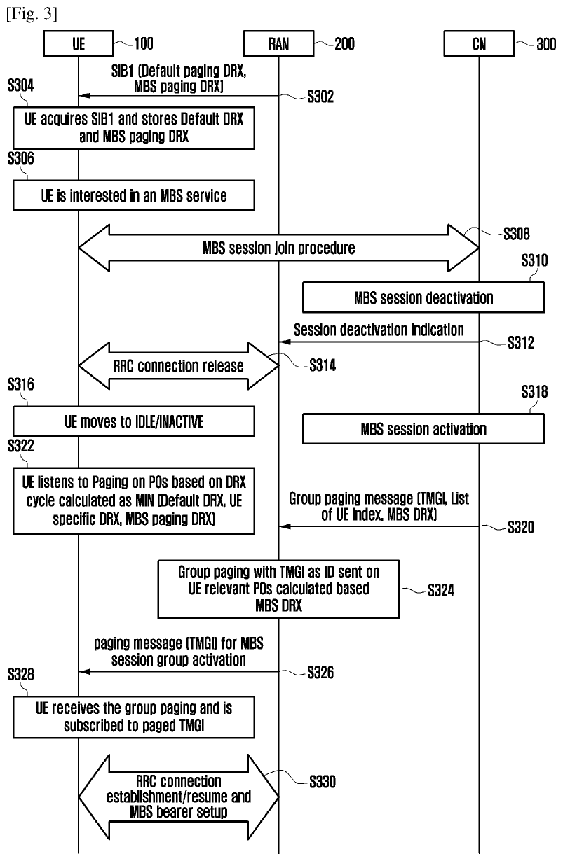

In an embodiment, the network device (400) signals the paging DRX cycles to be used for receiving MBS group paging or group notification in RRC_IDLE or RRC_INACTIVE state for at least one MBS session or for at least one group of MBS sessions or all MBS sessions as a common configuration using one or combination of the following ways (as depicted in FIGS. 2-FIG. 7), but is not limited to:
a. as part of System Information Block #1 (SIB1),
b. as part of MBS specific SIB,
c. during the MBS join procedure via a Non-Access Stratum (NAS) message,
d. as part of User Service Description (USD) based information,
e. signalled via RRC signalling as part of MBS configuration in RRCReconfiguration message and/or MBS specific RRC message,
f. signalled as part of RRC Release procedure in RRCRelease message or RRC Release with suspendConfig message, and
g. as part of existing SIB.

Further, as applicable to FIGS. 2-7 (not explicitly depicted), non-activated multicast session can correspond to the session which is configured or joined but it is not yet activated or it is deactivated after it was activated.

The MBS session specific DRX is provisioned by the network device (400) to the UE (100) to monitor the paging for multicast group notification (e.g., session activation) for that particular session. In an embodiment, the UE (100) is configured by the network device (400) with the MBS session specific DRX cycles as part of the NAS MBS session joining procedure using the PDU session modification command message. A new Information Element (IE) is introduced to configure the DRX paging cycle information per session and/or a group of sessions (requested in the joining procedure), if supported for that session and/or the group of sessions.

In an embodiment, the UE (100) is configured with the MBS session specific DRX cycle as part of the RRC release procedure via a RRC Release message or a RRC Release with suspendConfig message. A new Information element is introduced to signal the DRX cycle per MBS session joined by the UE (100).

In an embodiment, the UE (100) is provisioned the one or more common MBS paging DRX parameters and session specific DRX parameters for receiving MBS group paging or group notification in the RRC_IDLE or the RRC_INACTIVE state, as part of User Service Description (USD) information. If the UE (100) is interested in receiving the MBS session, the UE (100) uses one or combination of the following: common DRX value and session specific DRX cycle value, if available to calculate the paging occasions to receive group paging or group notification.

The following is a sample representation of the new IE introduced to Abstract Syntax Notation (ASN) structure by extending RRC Release IEs. The new IE introduced is used to configure a common DRX cycle for all MBS Sessions or MBS session specific DRX cycle.

```
  RRC Release IEs
  RRCRelease-v1650-IEs ::= SEQUENCE {
  mpsPriorityIndication-r16 ENUMERATED { true} OPTIONAL, -- Cond
Redirection2
  nonCriticalExtension RRCRelease-vXXXX-IEs OPTIONAL
  }
  RRCRelease-vXXXX-IEs ::= SEQUENCE {
  mbs-PagingCycle CHOICE {
  mbs-PagingCycleCommon PagingCycle,
  mbs-PagingCycleList SEQUENCE(0..maxNrofMBS-Session-r17) of
mbs-PagingCycle
  } OPTIONAL,
  nonCriticalExtension SEQUENCE { } OPTIONAL
  }
  mbs-PagingCycle-r17 ::= SEQUENCE {
  mbs-SessionId-r17 TMGI-r17,
  session-PagingCycle PagingCycle
  }
```

The mbs-PagingCycle defines the paging DRX cycle length used to calculate T and can be configured either as a common value for all MBS sessions or on a per MBS session basis. The mbs-PagingCycle-r17 indicates the paging cycle to be used for the associated MBS session ID.

In an embodiment, when multicast session group notification is provided with at least one of UE specific DRX and default DRX, the PF and PO for paging for multicast session group notification are determined by the following formulae:

SFN for the PF=(SFN+PF_offset)mod T=(T div N)*(UE_ID mod N)

Index (i_s), indicating the index of the PO is determined by:

i_s=floor(UE_ID/N)mod Ns

The following parameters are used for the calculation of PF and i_s above:
T: DRX cycle of the UE (100), wherein T is determined by the shortest of the UE specific DRX value(s) (if configured by RRC and/or upper layers) and a default DRX value broadcast in system information. In RRC_IDLE state, if the UE specific DRX is not configured by upper layers, the default value is applied,
N: number of total paging frames in T,
Ns: number of paging occasions for a PF,
PF_offset: offset used for PF determination, and
UE_ID: 5G-S-TMSI mod 1024.

In an embodiment, when multicast related UE specific DRX is configured for the UE (100), the UE (100) will monitor for paging frame and paging occasion for multicast session group notification with evaluating T as follows:

T: DRX cycle of the UE (100), where T is determined by the shortest of the UE specific DRX value(s) (if configured by RRC and/or upper layers), the multicast related UE specific DRX value(s) (if configured/provided by RRC and/or upper layers and a default DRX value broadcast in system information). In RRC_IDLE state, if the UE specific DRX is not configured by upper layers, the shortest of the multicast related UE specific DRX value(s), if configured/provided by RRC and/or upper layers and the default value is applied.

In an embodiment, when the multicast session specific DRX is configured for the UE (100), the UE (100) will monitor for paging frame and paging occasion for multicast session group notification with evaluating T as follows:

T: DRX cycle of the UE (100), wherein T is determined by the shortest of the UE specific DRX value(s) (if configured by RRC and/or upper layers), the multicast session specific DRX value(s) (if configured/provided by RRC and/or upper layers), Common MBS paging DRX value (if configured/provided by RRC and/or Upper Layer and/or System Information), and a default DRX value broadcast in system information. In RRC_IDLE state, if the UE specific DRX has not been configured by upper layers, the shortest of the multicast session specific DRX value(s), if configured/provided by RRC and/or upper layers, Common MBS paging DRX value if configured by RRC and/or Upper Layer and/or System Information and the default value is applied.

In an embodiment, T is determined in at least one of a RRC_IDLE state and a RRC_INACTIVE state by utilizing a formulation (e.g. shortest of) based on combination of one or more of the following parameters:
1. the UE specific DRX value(s) (if configured by RRC and/or upper layers),
2. the multicast session specific DRX value(s) (if configured/provided by RRC and/or upper layers),
3. Common MBS paging DRX value (if configured/provided by RRC and/or Upper Layer and/or System Information), and
4. a default DRX value broadcast in system information.

In another embodiment, the UE (100) uses the common multicast DRX value and/or the MBS session specific DRX value configured only, if the cell supports MBS and/or the interested service for which the UE (100) is listening for group paging or group notification.

If the cell does not support MBS and/or the interested session, the UE (100) uses only the default DRX value and UE specific DRX value, if configured already, to determine the T value to calculate Paging Occasion/Paging Frame.

In an embodiment, if the UE (100) receives a CN initiated paging for multicast session group notification in RRC_INACTIVE state, the UE (100) moves to RRC_IDLE and informs NAS.

In an embodiment, if the UE (100) receives the CN initiated paging for multicast session group notification in RRC_INACTIVE state, the UE (100) continues to stay in RRC_INACTIVE state and informs NAS. Further, the UE (100) pursues RRC connection resume procedure.

In an embodiment, the UE (100) decodes and/or processes the paging message for the group notification and not legacy unicast paging when paging occasion corresponds to UE specific DRX for MBS, or MBS session specific DRX but not to UE specific DRX for legacy unicast paging or not to default DRX.

In an embodiment, the network device (400) provides with at least one of PEI (Paging Early Indication), paging DCI (Downlink Control Information), short message indicator and short message that includes an indication (e.g. a bit or a bitmap or a field or an identification) to indicate if the paging message corresponds to at least one of a group notification for MBS (e.g. multicast session activation or multicast data arrival or multicast session release or multicast session deactivation) or a legacy unicast paging, a short message or a combination thereof. The UE (100) can accordingly pursue or skip the paging reception e.g. a non-MBS UE or UE with no non-activated multicast session need not monitor paging for group notification. This can also be efficient from UE power consumption perspective.

In an embodiment, a MBS UE which is expecting multicast session group notification (e.g. multicast session activation, activation or multicast data arrival or multicast session release or multicast session deactivation) needs to monitor paging for group notification irrespective of PEI. That is, this UE (100) can skip monitoring PEI and monitors the paging by default.

As shown in FIG. 2 and FIG. 3, in an embodiment, the multicast session group notification (or group paging) is provided through the pagingGroupList in the paging message carrying a list of TMGIs for which the session status is changed (e.g., activation, release).

In an embodiment, the pagingGroupList in the paging message also carries a field (e.g. termed as GroupPagingCause) for the cause or indication of the purpose of the group paging. The field can be present along with each TMGI in the pagingGroupList or as common field for all the TMGIs in the pagingGroupList. The field indicates a cause or purpose including but not limited to session release, session activation, session deactivation, session start. In another alternative, when this field is not present, the group paging is interpreted for session activation by default.

In an embodiment, the UE (100) which can be in one of RRC_IDLE state or RRC_INACTIVE state, forwards the TMGI and GroupPagingCause (if present) to the upper layer. The upper layer is thus notified for the session status for the TMGI(s) e.g. whether the session is activated or the session is released. If GroupPagingCause field is not present or is not notified to the upper layer, upper layer interprets the TMGI indicated is activated. The same approach can be applicable to each of the session or TMGI present in the paging message which is relevant to the UE (100).

In an embodiment, the UE (100) which is in RRC_INACTIVE state, when receives group paging with GroupPagingCause field not present or GroupPagingCause is set to ‘activation’ or GroupPagingCause is not set to ‘release’, the UE (100) initiates RRC connection resume procedure. The resume cause may be set to mt-Access or set in accordance with Access Identity configured by the upper layer.

In an embodiment, the UE (100) does not respond to the paging message if the message was received to indicate release of a multicast session the UE (100) had joined earlier. The UE (100) stops listening for group paging for the multicast session, and/or locally releases the multicast context. If the PDU session was activated only for the purpose of joining a multicast service, the UE (100) locally releases the PDU session. Additionally, the UE (100) synchronizes the list of active PDU sessions with the network whenever it next transitions to RRC_CONNECTED state.

Since the UE(s) (100) are not expected to respond to the paging message when it is sent to indicate release of multicast session, the network device (400) has no way of knowing that the UE(s) (100) indeed received the paging message. It is expected that the network device (400) deploys suitable paging retransmission strategies to increase the probability of UE(s) (100) receiving the message. It is to be noted though that the UE(s) (100) may miss paging message with either mechanism—one where they are expected to respond and one where they are not expected to respond.

In another embodiment, the UE (100) responds with an acknowledgement message to the paging message if the message was received to indicate release of a multicast session the UE (100) had joined earlier. Further, for the UE (100) in the RRC_INACTIVE state, the response can be sent using one of the Small Data Transmission (SDT) schemes if it was provisioned with configurations for SDT and the configurations are still valid. This alternative avoids blind paging retransmission efforts from the network.

In an embodiment, the UE (100) responds to the paging message if the message was received to indicate release of a multicast session the UE (100) had joined earlier. The UE (100) stops listening for group paging for the multicast session. UE transits to the RRC_CONNECTED state. Further, the UE (100) synchronizes the list of active PDU sessions with the network after transition to RRC_CONNECTED state.

In an embodiment, an example specification is presented to describe the operational steps for the UE (100), when it receives multicast session group notification (i.e. group paging) with release indication as follows:

### Reception of the Paging Message by the UE (100):

Upon receiving the paging message, the UE (100) shall:
1> if in RRC_IDLE, for each of the PagingRecord, if any, included in the Paging message:
2> if the ue-Identity included in the PagingRecord matches the UE identity allocated by upper layers:
3> forward the ue-Identity and accessType (if present) to the upper layers;
1> if in RRC_INACTIVE, for each of the PagingRecord, if any, included in the Paging message:
2> if the ue-Identity included in the PagingRecord matches the UE's stored full I-RNTI:
3> if the UE (100) is configured by upper layers with Access Identity 1:
4> initiate the RRC connection resumption procedure according to 5.3.13 (in the 3GPP TS 38.331 RRC specification) with resumeCause set to mps-PriorityAccess;
3> else if the UE (100) is configured by upper layers with Access Identity 2:
4> initiate the RRC connection resumption procedure according to 5.3.13 (in the 3GPP TS 38.331 RRC specification) with resumeCause set to mcs-PriorityAccess;
3> else if the UE (100) is configured by upper layers with one or more Access Identities equal to 11-15:
4> initiate the RRC connection resumption procedure according to 5.3.13 (in the 3GPP TS 38.331 RRC specification) with resumeCause set to high PriorityAccess;
3> else:
4> initiate the RRC connection resumption procedure according to 5.3.13 (in the 3GPP TS 38.331 RRC specification) with resumeCause set to mt-Access;
2> else if the ue-Identity included in the PagingRecord matches the UE identity allocated by upper layers:
3> forward the ue-Identity to upper layers and accessType (if present) to the upper layers;
3> perform the actions upon going to RRC_IDLE as specified in 5.3.11 with release cause ‘other’.
1> for each TMGI included in pagingGroupList, if any, included in the Paging message:
2> if the UE (100) is in the RRC_IDLE and has joined an MBS session indicated by the TMGI included in the pagingGroupList:
3> forward the TMGI and GroupPagingCause (if present) to the upper layers;
1> if in RRC_INACTIVE and the UE (100) has joined one or more MBS session(s) indicated by the TMGI included in the pagingGroupList:
2> if the GroupPagingCause is not present or GroupPagingCause is activation or GroupPagingCause is not release:
3> initiate the RRC connection resumption procedure according to 5.3.13 (in the 3GPP TS 38.331 RRC specification) with resumeCause set as per configured access identity.

In an embodiment, the UE (100) stops monitoring the group paging for the TMGI for which GroupPagingCause as ‘release’ is received, while the UE (100) continues to monitor the group paging for other relevant TMGI(s), if any.

In an embodiment, the UE (100) stops monitoring the group paging for any TMGI once pagingGroupList with at least one relevant TMGI are received wherein GroupPagingCause is not present or GroupPagingCause is set as ‘activation’ or GroupPagingCause is not set as ‘release’.

In an embodiment, upon getting the indication from a lower layer with release of at least one relevant TMGI, the upper layer requests the lower layer to stop monitoring of the group paging for the relevant TMGI.

In an embodiment, the NAS is informed about the session release only once UE (100) goes to RRC_CONNECTED state or is already in RRC_CONNECTED state (e.g. through NAS signalling) and not through group paging. In this case, the UE (100) continues to monitor group paging indefinitely in the RRC_IDLE state or the RRC_INACTIVE state. Once the UE (100) transits to RRC_CONNECTED state and NAS is informed about the session release, it informs the lower layer. The lower layer may release the MBS radio bearer configuration, if there is any, for the relevant TMGI.

In an embodiment, the NAS is informed about the session release only once the UE (100) goes to the RRC_CONNECTED state and not explicitly informed through group paging. Further, the network device (400) may send unicast paging or group paging to the UE (100) to come to RRC_CONNECTED state and then, performs release signalling with the NAS. Once NAS is informed about the session release, it informs the lower layer. The lower layer may release the MBS radio bearer configuration, if there is any, for the relevant TMGI.

In an embodiment, the UE (100) is in the RRC_INACTIVE state, when the UE (100) receives the CN paging and multicast session group notification (i.e. group paging) in the same paging message, the UE (100) forwards the UE identity and accessType (if present) in at least one of the paging record where the UE identity included in the paging record matches the UE identity allocated by upper layers as well as the UE (100) forwards the at least one of the TMGI which UE (100) has joined and indicated in the pagingGroupList in the paging message. Further, the UE (100) transitions to the RRC_IDLE state.

In an embodiment, the processing of the paging message is completed fully i.e. for all the paging records and the pagingGroupList, before the UE (100) performs the transition to the RRC_IDLE state in the case when the UE (100), in RRC_INACTIVE state, receives CN paging and multicast session group notification (i.e. group paging) in the same paging message.

In an embodiment, an example specification is presented to describe the operational steps for the UE (100) in the RRC_INACTIVE state, when the UE (100) receives the CN paging and multicast session group notification (i.e. group paging) in the same paging message as follows:

### In an Embodiment, Reception of the Paging Message by the UE (100).

Upon receiving the Paging message, the UE (100) shall:
1> if in RRC_IDLE, for each of the PagingRecord, if any, included in the Paging message:
2> if the ue-Identity included in the PagingRecord matches the UE identity allocated by upper layers:
3> forward the ue-Identity and accessType (if present) to the upper layers;
1> if in RRC_INACTIVE, for each of the PagingRecord, if any, included in the Paging message:
2> if the ue-Identity included in the PagingRecord matches the UE's stored full I-RNTI:
3> if the UE (100) is configured by upper layers with Access Identity 1:
4> initiate the RRC connection resumption procedure according to 5.3.13 (in the 3GPP TS 38.331 RRC specification) with resumeCause set to mps-PriorityAccess;
3> else if the UE (100) is configured by upper layers with Access Identity 2:
4> initiate the RRC connection resumption procedure according to 5.3.13 (in the 3GPP TS 38.331 RRC specification) with resumeCause set to mcs-PriorityAccess;
3> else if the UE (100) is configured by upper layers with one or more Access Identities equal to 11-15:
4> initiate the RRC connection resumption procedure according to 5.3.13 (in the 3GPP TS 38.331 RRC specification) with resumeCause set to high PriorityAccess;
3> else:
4> initiate the RRC connection resumption procedure according to 5.3.13 (in the 3GPP TS 38.331 RRC specification) with resumeCause set to mt-Access;
2> else if the ue-Identity included in the PagingRecord matches the UE identity allocated by upper layers:
3> forward the ue-Identity to upper layers and accessType (if present) to the upper layers;
3> perform the actions upon going to RRC_IDLE as specified in 5.3.11 with release cause ‘other’.
1> if UE (100) is in the RRC_IDLE and for each TMGI included in pagingGroupList, if any, included in the Paging message:
2> if the UE (100) has joined an MBS session indicated by the TMGI included in the pagingGroupList:
3> forward the TMGI to the upper layers;
1> if in RRC_INACTIVE and the UE (100) has joined one or more MBS session(s) indicated by the TMGI included in the pagingGroupList:
2> if the ue-Identity included in none of the PagingRecord matches the UE identity allocated by upper layers:
3> initiate the RRC connection resumption procedure according to 5.3.13 (in the 3GPP TS 38.331 RRC specification) with resumeCause set as per configured access identity.
2> else:
3> forward the TMGI to the upper layers;
In another embodiment: Reception of the Paging message by the UE (100)
Upon receiving the Paging message, the UE (100) shall:
1> if in RRC_IDLE, for each of the PagingRecord, if any, included in the Paging message:
2> if the ue-Identity included in the PagingRecord matches the UE identity allocated by upper layers:
3> forward the ue-Identity and accessType (if present) to the upper layers;
1> if in RRC_INACTIVE, for each of the PagingRecord, if any, included in the Paging message:
2> if the ue-Identity included in the PagingRecord matches the UE's stored full-RNTI:
3> if the UE (100) is configured by upper layers with Access Identity 1:
4> initiate the RRC connection resumption procedure according to 5.3.13 (in the 3GPP TS 38.331 RRC specification) with resumeCause set to mps-PriorityAccess;
3> else if the UE (100) is configured by upper layers with Access Identity 2:
4> initiate the RRC connection resumption procedure according to 5.3.13 (in the 3GPP TS 38.331 RRC specification) with resumeCause set to mcs-PriorityAccess;
3> else if the UE (100) is configured by upper layers with one or more Access Identities equal to 11-15:
4> initiate the RRC connection resumption procedure according to 5.3.13 (in the 3GPP TS 38.331 RRC specification) with resumeCause set to high PriorityAccess;
3> else:
4> initiate the RRC connection resumption procedure according to 5.3.13 (in the 3GPP TS 38.331 RRC specification) with resumeCause set to mt-Access;
2> else if the ue-Identity included in the PagingRecord matches the UE identity allocated by upper layers:
3> forward the ue-Identity to upper layers and accessType (if present) to the upper layers;
3> determine to going to RRC_IDLE.
1> for each TMGI included in pagingGroupList, if any, included in the Paging message:
2> if the UE (100) is in the RRC_IDLE and the UE (100) has joined an MBS session indicated by the TMGI included in the pagingGroupList:
3> forward the TMGI to the upper layers;
1> if in RRC_INACTIVE and the UE (100) has joined one or more MBS session(s) indicated by the TMGI included in the pagingGroupList:
2> if the ue-Identity included in none of the PagingRecord matches the UE identity allocated by upper layers:
3> initiate the RRC connection resumption procedure according to 5.3.13 (in the 3GPP TS 38.331 RRC specification) with resumeCause set as per configured access identity.
2> else:
3> forward the TMGI to the upper layers;
3> determine to going to RRC_IDLE.
1> If determined to going to RRC_IDLE, perform the actions upon going to RRC_IDLE as specified in 5.3.11 with release cause ‘other’.

In an embodiment, while transitioning to the RRC_IDLE state or the RRC_INACTIVE state, the UE (100) performs cell selection or reselection. Due to the cell selection or reselection, the UE (100) may or may not be on the same camped cell and it is also not guaranteed the newly selected cell supports MBS or specific multicast service e.g. new selected cell may be out of multicast coverage area. In another embodiment, as alternative approaches, the UE (100) performs at least one of the following actions:
a) The UE (100) skips performing cell selection or reselection while going to RRC_IDLE state or the RRC_INACTIVE state and thereby UE (100) maintains the same camped cell for operation;
b) The UE (100) performs the cell selection or reselection and ensures to select the same camped cell. For this purpose, the UE (100) prioritizes the camped cell;
c) The UE (100) performs the cell selection or reselection and ensures to select a cell for camping which supports the MBS and/or specific multicast service. For this purpose, the UE (100) may check the presence of scheduling of the SIBx (dedicated SIB for MBS) in SIB1 of the selected cell or selected cell belongs to the Service Area Identity (SAI) and/or frequency providing the MBS service.
d) The UE (100) performs cell selection or reselection as usual, however, if the newly camped cell does not support MBS or specific multicast service, the UE (100) performs cell reselection to a new cell which may support MBS or specific multicast service.
e) The UE (100) performs cell selection or reselection as usual, however, if the newly camped cell does not support MBS or specific multicast service, the UE (100), upon getting connected (i.e. in RRC_CONNECTED state) avails specific multicast service through unicast connection, or is handed over to a cell supporting MBS (or multicast service) by the network through handover procedure.

In an embodiment, while transitioning to RRC_IDLE state, UE (100) releases the suspended multicast MBS radio bearer(s) (MRBs) configuration, if any present, from the UE inactive AS context. The suspended multicast MBS radio bearer(s) configuration may have been stored while the UE (100) was earlier transitioned from RRC_CONNECTED state to RRC_INACTIVE state.

In an embodiment, when the upper layer (e.g. Non-Access Stratum, NAS) receives the at least one UE identity and accessType (if present) as well as at least one TMGI, the upper layer triggers the lower layer (e.g. Radio Resource Control, RRC) to initiate a RRC connection establishment with an establishment cause. The establishment cause is set to the higher priority cause among the cause for CN paging response and group paging cause. The higher priority may be set according to the Access Category and/or Access Identity for the unicast and/or multicast session and the UE (100). Further, highest priority as applicable may be selected among multiple multicast sessions (TMGIs) if they are paged together. The priority may also be selected on the basis of the UE's preference among MBS (or multicast) and unicast. For example, the UE (100) may have set or not set its preference for MBS over unicast and it is reported in MBS interest indication signalling.

In an embodiment, an example specification is presented to describe the operational steps for the UE (100) for both cases of groupPagingCause reception and simultaneous reception of CN paging and group paging as follows:

### Reception of the Paging Message by the UE (100):

Upon receiving the Paging message, the UE (100) shall:
1> if in RRC_IDLE, for each of the PagingRecord, if any, included in the Paging message:
2> if the ue-Identity included in the PagingRecord matches the UE identity allocated by upper layers:
3> forward the ue-Identity and accessType (if present) to the upper layers;
1> if in RRC_INACTIVE, for each of the PagingRecord, if any, included in the Paging message:
2> if the ue-Identity included in the PagingRecord matches the UE's stored full I-RNTI:
3> if the UE (100) is configured by upper layers with Access Identity 1:
4> initiate the RRC connection resumption procedure according to 5.3.13 (in the 3GPP TS 38.331 RRC specification) with resumeCause set to mps-PriorityAccess;
3> else if the UE (100) is configured by upper layers with Access Identity 2:
4> initiate the RRC connection resumption procedure according to 5.3.13 (in the 3GPP TS 38.331 RRC specification) with resumeCause set to mcs-PriorityAccess;
3> else if the UE (100) is configured by upper layers with one or more Access Identities equal to 11-15:
4> initiate the RRC connection resumption procedure according to 5.3.13 (in the 3GPP TS 38.331 RRC specification) with resumeCause set to high PriorityAccess;
3> else:
4> initiate the RRC connection resumption procedure according to 5.3.13 (in the 3GPP TS 38.331 RRC specification) with resumeCause set to mt-Access;
2> else if the ue-Identity included in the PagingRecord matches the UE identity allocated by upper layers:
3> forward the ue-Identity to upper layers and accessType (if present) to the upper layers;
3> perform the actions upon going to RRC_IDLE as specified in 5.3.11 with release cause ‘other’.
1> for each TMGI included in pagingGroupList, if any, included in the Paging message:
2> if the UE (100) is in the RRC_IDLE and has joined an MBS session indicated by the TMGI included in the pagingGroupList:
3> forward the TMGI and GroupPagingCause (if present) to the upper layers;
1> if in RRC_INACTIVE and the UE (100) has joined one or more MBS session(s) indicated by the TMGI included in the pagingGroupList:
2> if the ue-Identity included in none of the PagingRecord matches the UE identity allocated by upper layers; and
2> if the GroupPagingCause is not present or GroupPagingCause is activation or GroupPagingCause is not release:
3> initiate the RRC connection resumption procedure according to 5.3.13 (in the 3GPP TS 38.331 RRC specification) with resumeCause set as per configured access identity.
2> else:
3> forward the TMGI to the upper layers;
3> forward the GroupPagingCause (if present) to the upper layers;

In an embodiment, the UE (100) in RRC_INACTIVE state, when the UE (100) receives the CN paging and multicast session group notification (i.e. group paging) in the same paging message, the UE (100) forwards the UE identity and accessType (if present) in at least one of the paging record where the UE identity included in the paging record matches the UE identity allocated by upper layers as well as the UE (100) forwards the at least one of the TMGI which UE (100) has joined and indicated in the pagingGroupList in the paging message. Further, the UE (100) transits to the RRC_IDLE state. Upon triggering from the upper layer for sending paging response, the UE (100) initiates the RRC connection establishment procedure. The UE (100) sends a RRCSetupRequest message with an establishmentCause which may be set to an establishmentCause as determined by the upper layer.

In an embodiment, the UE (100) in the RRC_INACTIVE state, when the UE (100) receives the CN paging and multicast session group notification (i.e. group paging) in the same paging message, where the UE identity included in none of the paging record matches the UE identity allocated by upper layers, the UE (100) stays in the RRC_INACTIVE state (i.e. not goes to RRC_IDLE state) and initiates the RRC connection resumption procedure. The UE (100) sends a RRCResumeRequest or RRCResumeRequest1 message with a resumeCause which may be set in accordance with Access Identity configured by the upper layer.

In an embodiment, the UE (100) in the RRC_IDLE state, when the UE (100) receives the CN paging and multicast session group notification (i.e. group paging) in the same paging message, the UE (100) forwards the UE identity and accessType (if present) in at least one of the paging record where the UE identity included in the paging record matches the UE identity allocated by upper layers as well as UE (100) forwards the at least one of the TMGI which the UE (100) has joined and indicated in the pagingGroupList in the paging message. Further, the UE (100) stays in the RRC_IDLE state and upon triggering from upper layer for sending paging response, initiates the RRC connection establishment procedure. The UE (100) sends a RRCSetupRequest message with an establishmentCause which may be set to an establishmentCause as indicated by the upper layer.

In an embodiment, the processing of the paging message is completed fully i.e. for all the paging records and the pagingGroupList, in the case when the UE (100), in the RRC_IDLE state or in the RRC_INACTIVE state, receives CN paging and multicast session group notification (i.e. group paging) in the same paging message.

FIG. 1B shows various hardware components of the UE (100), according to the embodiments as disclosed herein. In an embodiment, the UE (100) includes a processor (110), a communicator (120), a memory (130) and a paging operation controller (140). The processor (110) is coupled with the communicator (120), the memory (130) and the paging operation controller (140).

In an embodiment, the paging operation controller (140) receives the paging message from the network device (400), where the UE (100) is in the RRC inactive state. Further, the paging operation controller (140) determines whether the UE (100) has received at least one of the CN paging and the group paging in the paging message. Upon determining that the UE (100) simultaneously receives the CN paging and the group paging in the paging message, the paging operation controller (140) sends the UE identity, the access type and the TMGI to the upper layer (e.g. NAS layer or the like) and transits the UE (100) into the RRC idle state from the RRC inactive state.

In another embodiment, the paging operation controller (140) determines that the UE (100), in the RRC inactive state, receives the CN paging only in the paging message upon determining that the UE (100) does not simultaneously receive the CN paging and the group paging in the paging message. Further, the paging operation controller (140) sends the UE identity and the access type to the upper layer and transits the UE (100) into the RRC idle state upon determining that the UE (100) receives the CN paging only in the paging message.

In another embodiment, the paging operation controller (140) determines that the UE (100), in the RRC inactive state, receives the group paging only in the paging message upon determining that the UE (100) does not simultaneously receive the CN paging and the group paging in the paging message. Further, the paging operation controller (140) performs at least one of: sending of the TMGI to the upper layer and initiates a RRC connection resume procedure upon determining that the UE (100) receives the group paging only in the paging message.

In another embodiment, the paging operation controller (140) receives the group paging through the paging group list in a paging message comprising the list of TMGIs for which the session status is explicitly or implicitly indicated. The paging group list in the paging message includes a field indicating a cause of the group paging, where the UE (100) is in one of a RRC inactive state and a RRC idle state. The field is present along with each TMGI in the paging group list or a common field for all the TMGIs in the paging group list.

Based on the group paging, the paging operation controller (140) determines whether the UE (100), in the RRC idle state or a RRC inactive state, receiving the group paging with the group paging cause is not present or the group paging cause is set to activation. In response to determine that the UE (100) receiving the group paging with the group paging cause is not present or the group paging cause is set to activation, the paging operation controller (140) sends the TMGI and the group paging cause to the upper layer and initiates a RRC connection establishment if the UE (100) is in the RRC idle state or a RRC connection resume procedure with a resume cause set in accordance with an access identity configured by the upper layer if the UE (100) is in the RRC inactive state. Alternatively, in response to determine that the UE (100) receiving the group paging with the group paging cause is present and the group paging cause is set to release or the group paging cause is not set to activation, the paging operation controller (140) determines that the UE (100) receives the group paging with the group paging cause set to release. Further, the paging operation controller (140) sends the TMGI and the group paging cause to the upper layer upon determining that the UE (100) receives the group paging with the group paging cause set to release. Further, the paging operation controller (140) stops monitoring of the group paging for TMGI.

The group paging includes a multicast session group notification, and where the group paging is provided through a paging group list in the paging message carrying a list of TMGIs for which a session status is explicitly or implicitly indicated. In an embodiment, the session status is explicitly indicated in which the paging group list in the paging message comprises a field indicating a group paging cause of the group paging. The field is present along with each TMGI in the paging group list or a common field for all the TMGIs in the paging group list. The group paging cause can be, for example, but not limited to a session release, a session activation, a session deactivation, and a session start.

In another embodiment, the session status is implicitly indicated in which the group paging is interpreted for session activation by default when the group paging cause field is not present in the paging message. In another embodiment, the session status is implicitly indicated in which the group paging cause field is not provided and the cause of the paging is determined by the UE (100) after getting connected to the network device (400) and receiving a RRC reconfiguration message from the network device (400).

The paging operation controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 1B shows various hardware components of the UE (100) but it is to be understood that other embodiments are not limited thereon. In other embodiments, the AMF apparatus (100) may include less or more number of components. Further, the labels or names of the components are used only for illustrative purpose and does not limit the scope of the invention. One or more components can be combined together to perform same or substantially similar function in the UE (100).

FIG. 1C shows various hardware components of the network device (400), according to the embodiments as disclosed herein. The network device (400) can be, for example, but not limited to NG-RAN node and a core network node. In an embodiment, the network device (400) includes a processor (410), a communicator (420), a memory (430) and a paging operation controller (440). The processor (410) is coupled with the communicator (420), the memory (430) and the paging operation controller (440).

The paging operation controller (440) utilizes the UE specific DRX parameter to page the UE (100) for the paging message in one of the RRC idle state and the RRC inactive state. The UE specific DRX parameter includes the paging DRX cycle length. Based on the UE specific DRX parameter, the paging operation controller (440) handles the paging operation in the wireless network (1000).

In an embodiment, upon determining the paging message is the RAN multicast group paging message when the UE (100) transits from the coverage of a first NG-RAN node to a coverage of the second NG-RAN node, the first NG-RAN node sends the RAN multicast group paging message including the UE specific DRX parameter to the second NG-RAN RAN node.

In another embodiment, upon determining the paging message is a multicast group paging message for the at least one NG-RAN node that has the UE (100) in the coverage, wherein the core network sends the multicast group paging message including the UE specific DRX parameter to a NG-RAN node.

In another embodiment, upon determining the paging message is a group paging for the UE (100) in a coverage area, wherein a NG-RAN node sends the group paging message based on the UE specific DRX parameter to the UE (100).

In an example, a message is sent by a network device (e.g. first NG-RAN node) to another network device (e.g., second NG-RAN node) to page UEs for the multicast session in Table 1.

TABLE 1

| IE/Group | | | IE type and | Semantics | | Assigned |
|---|---|---|---|---|---|---|
| Name | Presence | Range | reference | description | Criticality | Criticality |
| Message | M | | 9.2.3.1 | | YES | reject |
| Type | (mandatory) | | | | | |
| MBS | M | | 9.2.3.146 | | YES | reject |
| Session | | | | | | |
| ID | | | | | | |
| UE | | 1 | | | YES | reject |
| Identity | | | | | | |
| Index | | | | | | |
| List | | | | | | |
| >UE | | 1 .. | | | — | |
| Identity | | <maxnoof | | | | |
| Index | | UEIDO | | | | |
| Item | | indicesfor | | | | |
| | | MBSPaging> | | | | |
| >>CHOICE | M | | | | — | |
| UE | | | | | | |
| Identity | | | | | | |
| Index | | | | | | |
| Value | | | | | | |
| >>>Length- | | | | | | |
| 10 | | | | | | |
| >>>>Index | M | | BIT | Coded as | — | |
| Length-10 | | | STRING | specified in | | |
| | | | (SIZE(10)) | TS 38.304 | | |
| >>Paging | O (optional) | | UE | Includes | — | |
| DRX | | | Specific | the UE | | |
| | | | DRX | specific | | |
| | | | 9.2.3.143 | paging | | |
| | | | | cycle as | | |
| | | | | defined in | | |
| | | | | TS 38.304 | | |
| Multicast | M | | RAN | | YES | ignore |
| RAN | | | Paging | | | |
| Paging | | | Area | | | |
| Area | | | 9.2.3.38 | | | |

The IE indicates the UE specific paging cycle as defined in TS 36.304 and 38.304 in Table 2.

TABLE 2

| IE/Group | | | IE type and | Semantics |
|---|---|---|---|---|
| Name | Presence | Range | reference | description |
| UE Specific | M | | ENUMERATED | Unit is radio |
| DRX | | | (32, 64, 128, | frame. |
| | | | 256, . . . ) | |

The paging operation controller (440) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (410) is configured to execute instructions stored in the memory (430) and to perform various processes. The communicator (420) is configured for communicating internally between internal hardware components and with external devices via one or more networks. The memory (430) also stores instructions to be executed by the processor (410). The memory (430) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (430) may, in some examples, be considered a non-transitory storage medium. The term “non-transitory” may indicate that the storage medium is not embodied in a carrier wave or a propagated signal. However, the term “non-transitory” should not be interpreted that the memory (430) is non-movable. In certain examples, a non-transitory storage medium may store data that can, over time, change (e.g., in Random Access Memory (RAM) or cache).

Although the FIG. 1C shows various hardware components of the network device (400) but it is to be understood that other embodiments are not limited thereon. In other embodiments, the network device (400) may include less or more number of components. Further, the labels or names of the components are used only for illustrative purpose and does not limit the scope of the invention. One or more components can be combined together to perform same or substantially similar function in the network device (400).

FIG. 2 is a sequence diagram depicting a proposed procedure followed by the UE (100) to request for the UE specific paging DRX cycle for receiving MBS group paging or group notification in the RRC_IDLE or the RRC_INACTIVE state, when the UE (100) joins the MBS session, and the UE (100) uses the proposed procedure by sending a Registration Request message with Requested DRX Parameter IE, according to embodiments as disclosed herein.

As shown FIG. 2, at S202, the UE (100) is interested in the MBS service(s). At S204, the MBS session join procedure is established between the UE (100) and the CN (300). At S206, the UE (100) requests the UE specific DRX value to meet the MBS session(s) requirements. At S208, the UE (100) sends a NAS PDU registration request including a requested DRX parameter IE to the CN (300). At S210, the CN (300) sends a NAS PDU: Registration accept including the negotiated DRX parameter IE to the UE (100). At S212, the CN (300) and/or RAN (200) determines the MBS session deactivation. At S214, the RAN (200) sends a session deactivation indication to the UE (100). At S216, the RRC connection is released between the UE (100) and the RAN (200) (e.g. when UE receives RRCRelease or RRCRelease with suspendConfig).

At S218, the UE (100) moves to the idle state/the inactive state. At S220, the CN (300) determines the MBS session activation. At S222, the CN (300) sends the group paging message (e.g., TMGI, List of UE Identity index value, UE specific DRX) to the RAN (200). At S224, the UE (100) listens to paging on the POs based on DRX cycle calculated as MIN (Default DRX, UE Specific DRX). At S226, the RAN (200) determines the group paging with TMGI as ID sent on the UE relevant POs calculated based on the UE specific DRX. At S228, the RAN (200) sends the paging message (TMGI) for MBS session group activation to the UE (100). At S230, the UE (100) receives the group paging and is subscribed to paged TMGI. At S232, the RRC connection establishment/resume and MBS bearer setup is done between the UE (100) and the RAN (200).

FIG. 3 is a sequence diagram depicting the common MBS DRX configuration signalled as part of SIB1 or other SIB message for receiving MBS group paging or group notification in the RRC_IDLE or a RRC_INACTIVE state, according to embodiments as disclosed herein.

As shown in FIG. 3, at S302, the RAN (200) sends the SIB1 (including default paging DRX and MBS paging DRX) to the UE (100). At S304, the UE (100) acquires the SIB1 and stores the default DRX and MBS paging DRX. At S306, the UE (100) is interested in the MBS service. At S308, the MBS session join procedure is established between the UE (100) and the CN (300). At S310, the CN (300) determines the MBS session deactivation. At S312, the CN (300) sends the session deactivation indication to the RAN (200). At S314, the RRC connection is released between the UE (100) and the RAN (200) (e.g. when the UE (100) receives RRCRelease or RRCRelease with suspendConfig). At S316, the UE (100) moves to the idle state/inactive state. At S318, the CN (300) determines the MBS session activation. At S320, the CN (300) sends the group paging message (including the TMGI, list of UE Identity Index value, and MBS DRX) to the RAN (200). At S322, the UE (100) listens to the paging on the POs based on DRX cycle calculated as MIN (Default DRX, UE specific DRX, MBS paging DRX). At S324, the RAN (224) determines the group paging with the TMGI as ID sent on the UE relevant POs calculated based the MBS DRX. At S326, the RAN (200) sends the paging message (TMGI) for MBS session group activation to the UE (100). At S328, the UE (100) receives the group paging and is subscribed to paged TMGI. At S330, the RRC connection establishment/resume and MBS bearer setup is done between the UE (100) and the RAN (200).

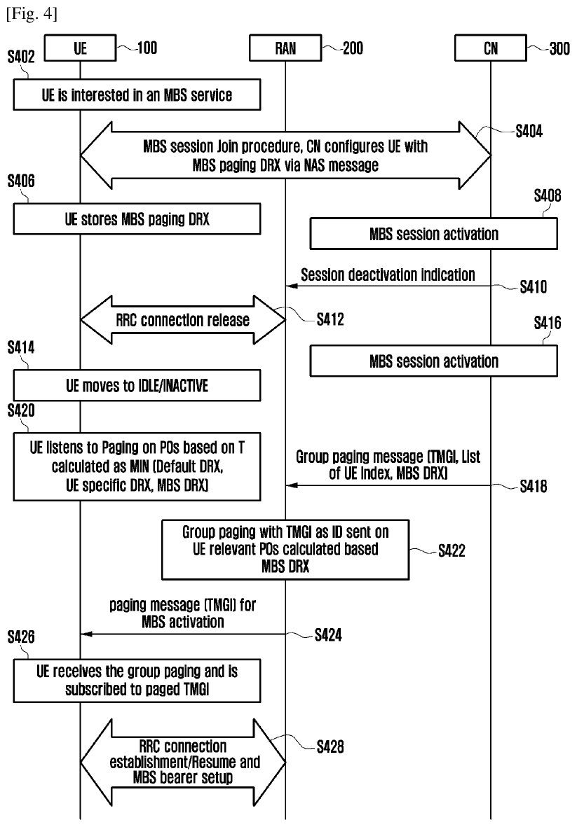

FIG. 4 is a sequence diagram depicting the MBS feature specific paging DRX cycle being configured as part of the MBS session join procedure for receiving MBS group paging or group notification in the RRC_IDLE or the RRC_INACTIVE state, according to embodiments as disclosed herein.

At S402, the UE (100) is interested in the MBS service. At S404, the MBS session join procedure is established between the UE (100) and the CN (300). The CN (300) configures the UE (100) with the MBS paging DRX via the NAS message. At S406, the UE (100) stores the MBS paging DRX. At S408, the CN (300) determines the MBS session deactivation. At S410, the CN (300) sends the session deactivation indication to the RAN (200). At S412, the RRC connection is released between the UE (100) and the RAN (200) (e.g. when the UE (100) receives RRCRelease or RRCRelease with suspendConfig). At S414, the UE (100) moves to the idle/inactive state. At S416, the CN (300) determines the MBS session activation.

At S418, the CN (300) sends the group paging message (including the TMGI, list of UE Identity index value, and MBS DRX) to the RAN (200). At S420, the UE (100) listens to the paging on the POs based on DRX cycle calculated as MIN (Default DRX, UE specific DRX, and MBS DRX). At S422, the RAN (200) determines the group paging with TMGI as ID sent on the UE (100) relevant POs calculated based MBS DRX. At S424, the RAN (200) sends the paging message (TMGI) for MBS activation to the UE (100). At S426, the UE (100) receives the group paging and is subscribed to paged TMGI. At S428, the RRC connection establishment/resume and MBS bearer setup is established between the UE (100) and the RAN (200).

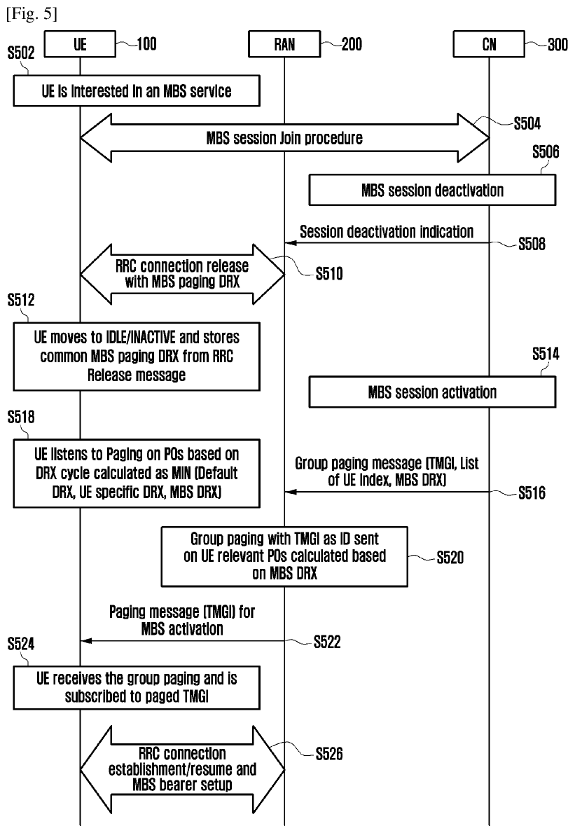

FIG. 5 is a sequence diagram depicting the MBS feature specific paging DRX cycle being configured as part of the connection release procedure in RRCRelease message for receiving MBS group paging or group notification in the RRC_IDLE or the RRC_INACTIVE state, according to embodiments as disclosed herein.

As shown in FIG. 5, at S502, the UE (100) is interested in the MBS service. At S504, the MBS session join procedure is established between the UE (100) and the CN (300). At S506, the CN (300) determines the MBS session deactivation. At S508, the CN (300) sends the session deactivation indication to the RAN (200). At S510, the RRC connection release is received providing with the MBS paging DRX between the UE (100) and the RAN (200). At S512, the UE (100) moves to the idle/inactive state and stores the common MBS paging DRX from the RRC release or RRC Release with suspendConfig message. At S514, the CN (300) determines the MBS session activation. At S516, the CN (300) sends the group paging message (including the TMGI, list of UE Identity index value, and the MBS DRX) to the RAN (200). At S518, the UE (100) listens to the paging on the POs based on calculated DRX cycle as MIN (Default DRX, UE specific DRX, and MBS DRX). At S520, the RAN (200) determines the group paging with TMGI as ID sent on the UE (100) relevant POs calculated based on the MBS DRX. At S522, the RAN (200) sends the paging message (TMGI) for the MBS activation to the UE (100). At S524, the UE (100) receives the group paging and is subscribed to paged TMGI. At S526, the RRC connection establishment/resume and MBS bearer setup is established between the UE (100) and the RAN (200).

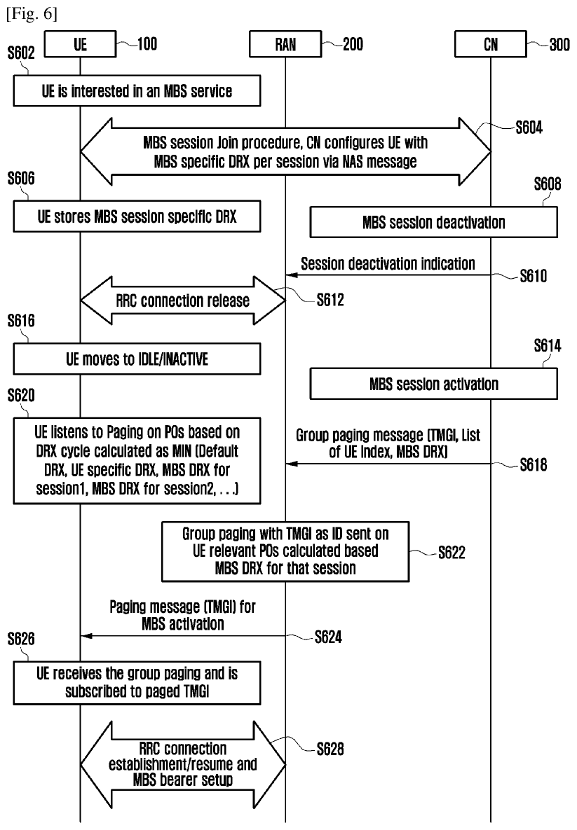

FIG. 6 is a sequence diagram depicting a MBS session specific paging DRX cycle being configured as part of the MBS session join procedure for receiving MBS group paging or the group notification in the RRC_IDLE or the RRC_INACTIVE state, according to embodiments as disclosed herein.

As shown in FIG. 6, at S602, the UE (100) is interested in the MBS service. At S604, the MBS session join procedure is established between the UE (100) and the CN (300). The CN (300) configures the UE with MBS specific DRX per session via the NAS message. At S606, the UE (100) stores the MBS session specific DRX. At S608, the CN (300) determines the MBS session deactivation. At S610, the CN (300) sends the session deactivation indication to the RAN (200). At S612, the RRC connection is released between the UE (100) and the RAN (200). At S614, the CN (300) determines the MBS session activation. At S616, the UE (100) moves to idle/inactive state (e.g. when UE receives RRCRelease or RRCRelease with suspendConfig). At S618, the CN (300) sends the group paging message (including the TMGI, the list of UE Identity Index value, and the MBS DRX) to the RAN (200). At S620, the UE (100) listens to the paging on POs based on DRX cycle calculated as MIN (Default DRX, UE specific DRX, MBS DRX for session1, MBS DRX for session2, . . . ). At S622, the RAN (200) determines the group paging with TMGI as ID sent on the UE (100) relevant POs calculated based MBS DRX for that session. At S624, the RAN (200) sends the paging message (TMGI) for MBS activation. At S626, the UE (100) receives the group paging and is subscribed to paged TMGI. At S628, the RRC connection establishment/resume and MBS bearer setup is established between the UE (100) and the RAN (200).

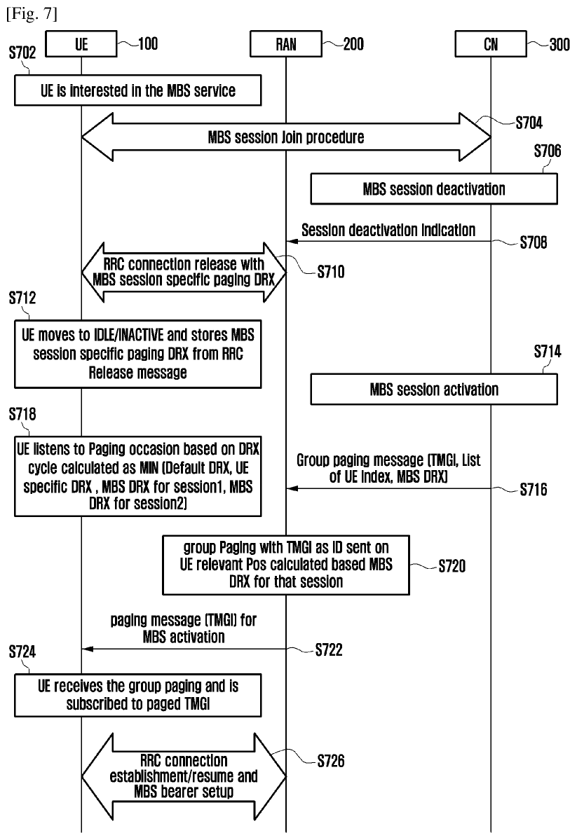

FIG. 7 is a sequence diagram depicting the MBS session specific paging DRX cycle being configured as part of the Connection release procedure in RRCRelease message for receiving MBS group paging or group notification in RRC_IDLE or RRC_INACTIVE state, according to embodiments as disclosed herein.

As shown in FIG. 7, at S702, the UE (100) is interested in a MBS service. At S704, the MBS session join procedure is established between the UE (100) and the CN (300). At S706, the CN (300) determines the MBS session deactivation. At S708, CN (300) sends the session deactivation indication to the RAN (200). At S710, the RRCRelease or RRCRelease with suspendConfig is received with MBS session specific paging DRX between the UE (100) and the RAN (200).

At S712, the UE (100) moves to the idle/inactive state and stores the MBS session specific paging DRX from the RRC Release or RRCRelease with suspendConfig message. At S714, the CN (300) determines the MBS session activation. At S716, the CN (300) sends the group paging message (including the TMGI, the list of UE Identity Index value, and the MBS DRX) to the RAN (200). At S718, the UE (100) listens to the paging occasion based on the DRX cycle calculated as MIN (Default DRX, UE specific DRX, MBS DRX for session1, MBS DRX for session2, . . . ). At S720, the RAN (200) determines the group paging with the TMGI as ID sent on the UE relevant PoS calculated based MBS DRX for that session. At S722, the RAN (200) sends the paging message (TMGI) for the MBS activation to the UE (100). At S724, the UE (100) receives the group paging and is subscribed to paged TMGI. At S726, the RRC connection establishment/resume and MBS bearer setup is established between the UE (100) and the RAN (200).

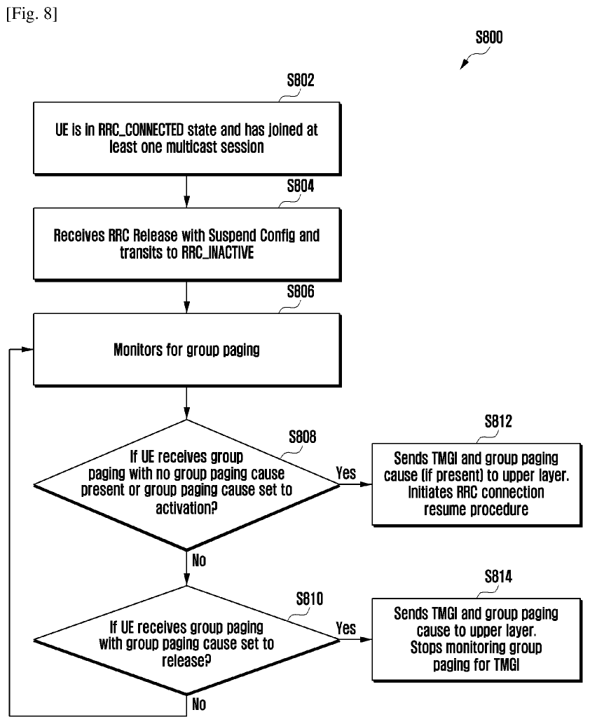

FIG. 8 is a flow chart (S800) illustrating a scenario of group paging for the UE (100) in the RRC_INACTIVE state, according to the embodiments as disclosed herein. The operations (S802-S814) may be handled by the paging operation controller (140).

At S802, the UE (100) is in the RRC_CONNECTED state and has joined at least one multicast session. At S804, the method includes receiving the RRC release with suspend config and transiting to the RRC INACTIVE state. At S806, the method includes monitoring for the group paging. At S808, the method includes determining whether the UE (100) receives the group paging with no group paging cause present or group paging cause set to activation? In response to determining that the UE (100) receives the group paging with no group paging cause present or group paging cause set to activation then, at step S812, the method includes sending at least one of the TMGI and the group paging cause (if present) to the upper layer and initiating the RRC connection resume procedure. In response to determining that the UE (100) does not receive the group paging with no group paging cause present or group paging cause set to activation then, at step S810, the method includes determining whether the UE (100) receives group paging with the group paging cause set to release? In response to determining that the UE (100) receives the group paging with the group paging cause set to release then, at step S814, the method includes sending the at least one of TMGI and group paging cause to upper layer. Further, the method includes stopping the monitoring group paging for TMGI.

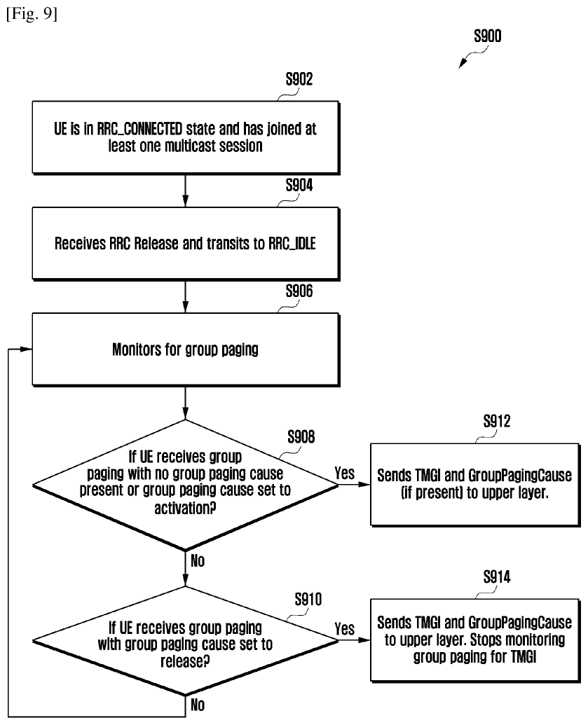

FIG. 9 is a flow chart (S900) illustrating a scenario of group paging procedure for the UE (100) in the RRC_IDLE state, according to the embodiments as disclosed herein. The operations (S902-S914) may be handled by the paging operation controller (140).

At S902, the UE (100) is in the RRC_CONNECTED state and has joined at least one multicast session. At S904, the method includes receiving the RRC release and transits to the RRC idle state. At S906, the method includes monitoring for the group paging. At S908, the method includes determining whether the UE (100) receives the group paging with no group paging cause present or group paging cause set to activation? In response to determining that the UE (100) receives the group paging with no group paging cause present or group paging cause set to activation then, at step 912, the method includes sends the TMGI and the group paging cause (if present) to the upper layer. In response to determining that the UE (100) does not receive the group paging with no group paging cause present or group paging cause set to deactivation then, at step 910, the method includes determining whether the UE (100) receives group paging with the group paging cause set to release? In response to determining that the UE (100) receives the group paging with the group paging cause set to release then, at step 914, the method includes sending the TMGI and group paging cause to upper layer. Further, the method includes stopping the monitoring group paging for TMGI.

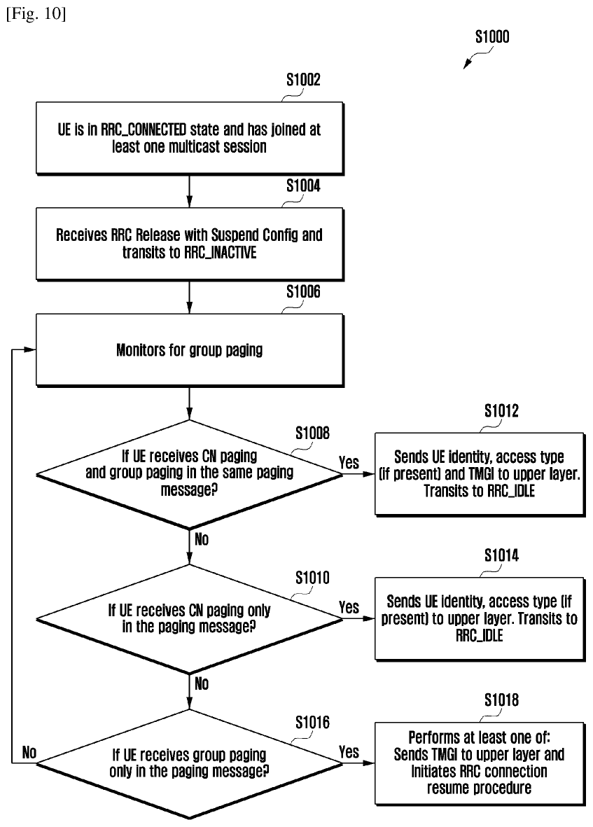

FIG. 10 is a flow chart (S1000) illustrating a scenario of paging procedure for the UE (100) in the RRC_INACTIVE where the CN paging and group paging can be received in the same paging message, according to the embodiments as disclosed herein. The operations (S1002-S1018) may be handled by the paging operation controller (140).

As shown in FIG. 10, at step S1002, the UE (100) is in the RRC_CONNECTED state and has joined at least one multicast session. At step S1004, the method includes receiving the RRC release with the suspend config and transiting to the RRC_INACTIVE. At step S1006, the method includes monitoring for group paging. At step S1008, the method includes determining whether the UE (100) receives the CN paging and the group paging in the paging message? In response to receiving the UE (100) receives the CN paging and the group paging in the paging message then, at S1012, the method includes sending the UE identity, the access type (if present) and the TMGI to the upper layer. Further, the method includes transiting the UE (100) into the RRC idle state.

In response to receiving the UE (100) does not receive the CN paging and the group paging in the paging message then, at S1010, the method includes determining whether the UE (100) receives the CN paging only in the paging message. In response to determining that the UE (100) receives the CN paging only in the paging message at S1014, the method includes sending the UE identity and access type (if present) to the upper layer. Further, the method includes transiting the UE (100) into the RRC idle state. In response to determining that the UE (100) does not receive the CN paging only in the paging message at S1016, the method includes determining whether the UE (100) receives the group paging only in the paging message? In response to determining that the UE (100) receives the group paging only in the paging message then, at S1018, the method includes performing at least one of sending the TMGI to upper layer and initiating the RRC connection resume procedureWhen no paging is received by the UE (100), then at step S1006, the method includes further monitoring for group paging.

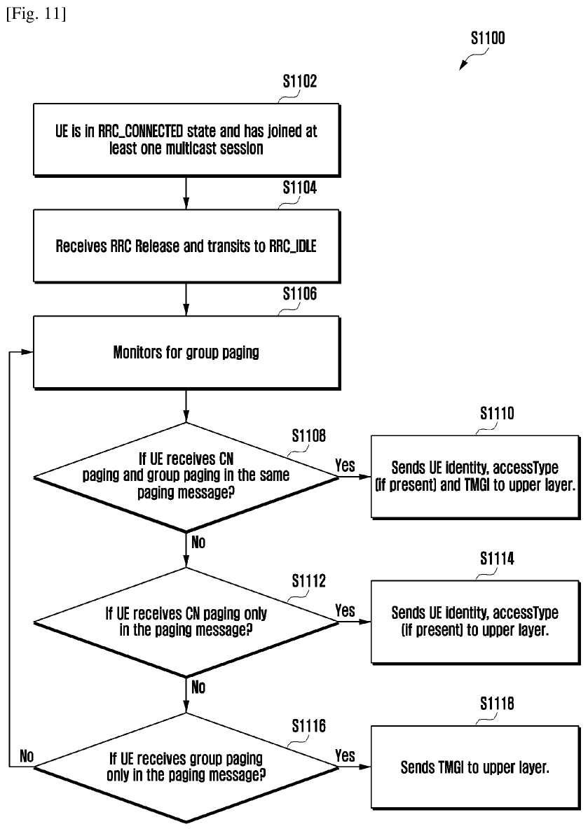

FIG. 11 is a flow chart (S1100) illustrating a scenario of paging procedure for the RRC_IDLE UE wherein CN paging and group paging can be received in the same paging message, according to the embodiments as disclosed herein. The operations (S1102-S1118) may be handled by the paging operation controller (140).

As shown in FIG. 11, at step S1102, the UE (100) is in the RRC_CONNECTED state and has joined at least one multicast session. At step S1104, the method includes receiving the RRC release and transiting the UE (100) to the RRC idle state. At step S1106, the method includes monitoring for the group paging. At step S1108, the method includes determining whether the UE (100) receives the CN paging and the group paging in the paging message? In response to receiving the UE (100) receives the CN paging and the group paging in the paging message then, at S1110, the method includes sending the UE identity, the access type (if present) and the TMGI to the upper layer.

In response to receiving the UE (100) does not receive the CN paging and the group paging in the paging message then, at S1112, the method includes determining whether the UE (100) receives the CN paging only in the paging message. In response to determining that the UE (100) receives the CN paging only in the paging message at S1114, the method includes sending the UE identity and access type (if present) to the upper layer. In response to determining that the UE (100) does not receive the CN paging only in the paging message at S1116, the method includes determining whether the UE (100) receives the group paging only in the paging message? In response to determining that the UE (100) receives the group paging only in the paging message then, at S1118, the method includes sending the TMGI to upper layer. In response to determining that the UE (100) does not receive the group paging or CN paging in the paging message then, at step S1106, the method includes further monitoring for group paging.

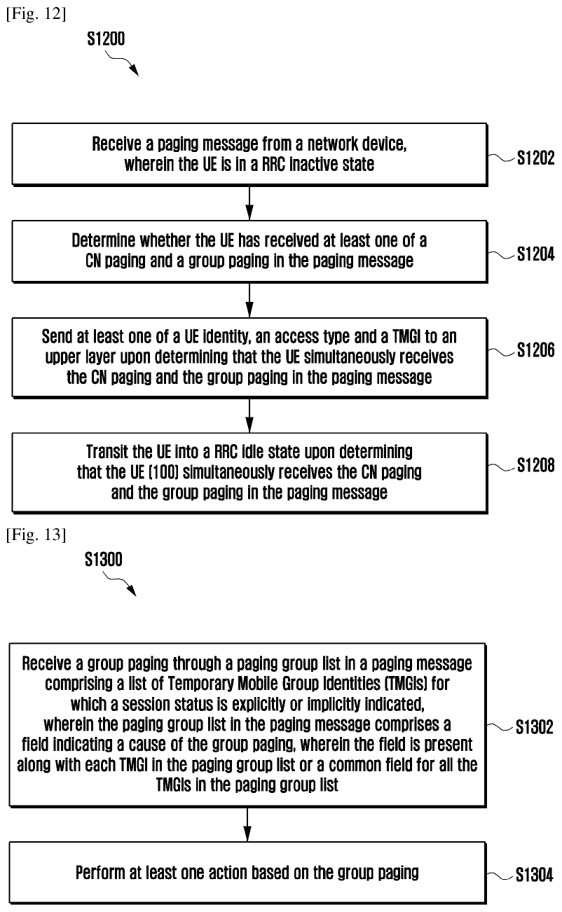

FIG. 12 and FIG. 13 are flow charts (S1200 and S1300) illustrating, implemented by the UE (100), the methods for handling the paging operation in the wireless network (1000), according to the embodiments as disclosed herein.

As shown in FIG. 12, the operations (S1202-S1208) may be handled by the paging operation controller (140). At S1202, the method includes receiving the paging message from the network device (400), where the UE (100) is in the RRC inactive state. At S1204, the method includes determining whether the UE (100) has received at least one of the CN paging and the group paging in the paging message. At S1206, the method includes sending at least one of the UE identity, the access type and the TMGI to the upper layer (e.g., NAS layer or the like) upon determining that the UE (100) simultaneously receives the CN paging and the group paging in the paging message. At S1208, the method includes transiting the UE (100) into the RRC idle state from the RRC inactive state upon determining that the UE (100) simultaneously receives the CN paging and the group paging in the paging message.

As shown in FIG. 13, the operations (S1302 and S1304) are handled by the paging operation controller (140). At S1302, the method includes receiving the group paging through the paging group list in the paging message comprising the list of TMGIs for which the session status is explicitly or implicitly indicated. The paging group list in the paging message comprises a field indicating the cause of the group paging. The field is present along with each TMGI in the paging group list or a common field for all the TMGIs in the paging group list. At S1304, the method includes performing the at least one action based on the group paging.

In an embodiment, perform the at least one action includes determine whether the UE (100), in a RRC idle state or a RRC inactive state, receiving the group paging with the group paging cause is not present or the group paging cause is set to activation. In response to determine that the UE (100) receiving the group paging with the group paging cause is not present or the group paging cause is set to activation, sending at least one of the TMGI and the group paging cause to an upper layer and initiating a RRC connection establishment if the UE (100) is in the RRC idle state or the RRC connection resume procedure with the resume cause set in accordance with an access identity configured by the upper layer if the UE (100) is in the RRC inactive state. In response to determine that the UE (100) receiving the group paging with the group paging cause is present or the group paging cause is not set to activation, determining that the UE (100) receives the group paging with the group paging cause set to release.

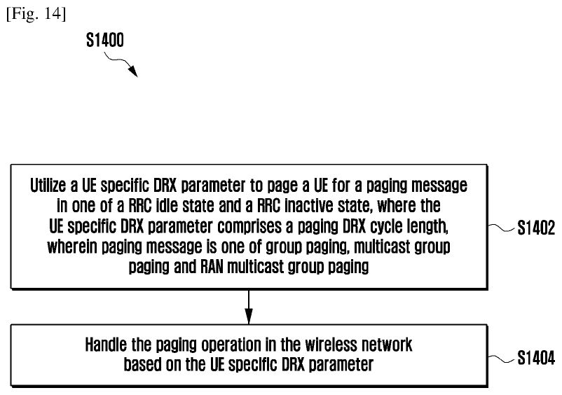

FIG. 14 is a flow chart (S1400) illustrating the methods, implemented by the network device (400), for handling the paging operation in the wireless network (1000), according to the embodiments as disclosed herein. As shown in FIG. 14, the operations (S1402 and S1404) may be handled by the paging operation controller (440).

At S1402, the method includes utilizing the UE specific DRX parameter to page the UE (100) for the paging message in one of the RRC idle state and the RRC inactive state, where the UE specific DRX parameter includes the paging DRX cycle length, wherein paging message is one of group paging, multicast group paging and RAN multicast group paging.

At S1404, the method includes handling the paging operation in the wireless network (1000) based on the UE specific DRX parameter.

The various actions, acts, blocks, steps, or the like in the flow charts (S800 to S1400) may be performed in the order presented, in a different order or simultaneously. Further, in some embodiments, some of the actions, acts, blocks, steps, or the like may be omitted, added, modified, skipped, or the like without departing from the scope of the invention.

The embodiments disclosed herein can be implemented through at least one software program running on at least one hardware device and performing network management functions to control the elements. The elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment herein, those skilled in the art will recognize that the embodiments herein can be practiced with modification within the spirit and scope of the embodiments as described herein.

1. A method performed by a terminal in a wireless communication system, the method comprising:
receiving, from a base station, a paging message, the terminal being in a radio resource control (RRC) inactive state;
identifying whether the paging message includes at least one of paging information and group paging information; and
forwarding, to an upper layer, at least one of a user equipment (UE) identity, an access type and a group identity, based on a result of the identification.

2. The method of claim 1, further comprises:
transiting an RRC state from the RRC inactive state to an RRC idle state.

3. The method of claim 1, wherein the forwarding further comprises:
identifying whether a UE identity included in the paging information matches a UE identity allocated by the upper layer; and
forwarding, to the upper layer, the UE identity and the access type, in case that the UE identity included in the paging information matches the UE identity allocated by the upper layer.

4. The method of claim 3, further comprises:
identifying whether the terminal is joined at least one MBS session indicated by a group identity included in the group paging information; and
forwarding, to the upper layer, the group identity in case that the terminal is joined the at least one MBS session indicated by the group identity included in the group paging information.

5. The method of claim 1, wherein the receiving further comprises:
identifying a UE specific DRX cycle for paging the terminal for a multicast session; and
receiving the paging message based on the UE specific DRX cycle.

6. The method of claim 1, wherein the group paging information included in the paging message further comprises information indicating a session status change.

7. The method of claim 1, wherein the group identity is a temporary mobile group identity (TMGI).

8. A terminal in a wireless communication system, the terminal comprising:
a transceiver; and
at least one processor is configured to:
receive, from a base station via the transceiver, a paging message, the terminal being in a radio resource control (RRC) inactive state, identify whether the paging message includes at least one of paging information and group paging information, and
forward, to an upper layer, at least one of a user equipment (UE) identity, an access type and a group identity, based on a result of the identification.

9. The terminal of claim 8, wherein the at least one processor is further configured to transit an RRC state from the RRC inactive state to an RRC idle state.

10. The terminal of claim 8, wherein the at least one processor is further configured to:
identify whether a UE identity included in the paging information matches a UE identity allocated by the upper layer, and
forward, to the upper layer, the UE identity and the access type, in case that the UE identity included in the paging information matches the UE identity allocated by the upper layer.

11. The terminal of claim 10, wherein the at least one processor is further configured to:
identify whether the terminal is joined at least one MBS session indicated by a group identity included in the group paging information, and
forward, to the upper layer, the group identity in case that the terminal is joined the at least one MBS session indicated by the group identity included in the group paging information.

12. The terminal of claim 8, wherein the at least one processor is further configured to:
identify a UE specific DRX cycle for paging the terminal for a multicast session, and
receive, via the transceiver, the paging message based on the UE specific DRX cycle.

13. The terminal of claim 8, wherein the group paging information included in the paging message further comprises information indicating a session status change.

14. The terminal of claim 8, wherein the group identity is a temporary mobile group identity (TMGI).
